(19) United States
(12) Patent Application Publication
(10) Pub. No.: US 2006/0121222 A1
(43) Pub. Date: Jun. 8, 2006

(54) Container for the packaging of products, device for processing plastics and method for production of a container

(76) Inventors: Peter Andrich, Glen Gardner, NJ (US); Klaus Hartwig, Hamburg (DE)

Correspondence Address: FRIEDRICH KUEFFNER, 317 MADISON AVENUE, SUITE 910, NEW YORK, NY, 10017, US

(21) Appl. No.: 10/527,208

(22) PCT Filed: Aug. 19, 2003
(86) PCT No.: PCT/IB03/04003

§ 371 Date: Nov. 7, 2005

(30) Foreign Application Priority Data
Sep. 11, 2002 (DE) 102 42 086.6

(51) Int. Cl. B32B 27/08

(52) U.S. Cl. 428/35.7

(57) ABSTRACT

The container for packaging is made from a thermoplastic plastic and is coated in the region of the inner surface thereof, such that a release of components contained within the plastic into the product packed in the container is prevented or at least significantly reduced. The coating can be applied by means of a plasma coating. The device for the production of preforms and the method for production of containers is essentially based on a direct coupling of a reactor for production of the plastic to an injection moulding device for the production of preforms. The preforms are then moulded to give the container by a blow forming process and the inner surface thereof is then provided with the coating.

The invention concerns a container for packaging products, which has a wall made of a thermoplastic material that contains at least one constituent that can be released at least from certain regions of the container into the interior of the container.

The invention also concerns an installation for producing preforms from a thermoplastic material, which has an injection-molding machine with cavities for the preforms. The invention also concerns a method for producing containers from a thermoplastic material, in which the plastic is produced in a reactor and then shaped into preforms by an injection-molding machine, and in which the preforms are formed into containers by blow molding, and then at least a portion of the inner surface of the containers is coated by a plasma coating process.

Containers of this type can consist, for example, of PET and can be used to package beverages or other liquids. Especially in the case of the packaging of beverages or other foods, there are strict requirements on the purity of the materials that are used. These requirements conflict with the likewise desired use of recycled materials for reasons of environmental protection, since materials of this type often contain impurities.

A well-known compromise solution between these different requirements is first to produce multilayer preforms by injection molding and then to form them into containers by blow molding. The multiple layers are formed in such a way that at least one inner layer made of a recycled material is covered by outer layers made of fresh material, so that the product to be packaged does not come into contact with the recycled material. However, the production of suitable preforms requires the use of expensive special injection-molding machines, and this results in a high product price.

Another problem with respect to the selection of materials for the containers is that the plastics that are used generally are not gastight. This allows especially oxygen to penetrate the container and carbon dioxide to escape from carbonated beverages, for example, soft drinks, mineral water, or beer. To improve the barrier properties of the containers, multilayer containers are also widely used, in which a special barrier layer made of a barrier material that is different from the primary material is applied. Here again, the production of the corresponding preforms is expensive. In addition, the combination of different materials leads to recycling problems, because the different materials often cannot be easily separated.

Another method for improving the barrier properties consists in plasma coating the container material. This coating can be applied on both the interior and exterior surface. Especially coating with silicon oxides has proven effective.

PCT-WO 95/22413 describes a plasma chamber for coating the inner surface of PET bottles. The bottles to be coated are raised into a plasma chamber by a movable base and connected at their mouths to an adapter. The inside of the bottles can be evacuated through the adapter. A hollow lance for supplying process gas is also inserted into the inside of the bottles through the adapter. Microwaves are used to ignite the plasma.

The same publication also describes the arrangement of a plurality of plasma chambers on a rotating wheel. This helps achieve a high production rate of bottles per unit time.

EP-OS 10 10 773 describes a feeding device for evacuating the inside of a bottle and supplying it with process gas. PCT-WO 01/31680 describes a plasma chamber into which the bottles are introduced by a movable lid that has first been connected with the mouths of the bottles.

PCT-WO 00/58631 also already describes the arrangement of plasma stations on a rotating wheel and the assignment of groups of vacuum pumps and plasma stations for an arrangement of this type to help provide favorable evacuation of the chambers and the interiors of the bottles. It also mentions the coating of several containers in a common plasma station or a common cavity.

Another system for coating the inside surfaces of bottles is described in PCT-WO 99/17334. This document describes especially an arrangement of a microwave generator above the plasma chamber and means for evacuating the plasma chamber and feeding it operating agents through the floor of the plasma chamber.

In most of the previously known plasma coating methods, silicon oxide coatings, which have the general chemical formula SiOₓ and are produced on the surface of the containers by the plasma, are used to improve the barrier properties of the thermoplastic material. In addition, the barrier layers produced in this way can contain carbon, hydrogen, and nitrogen components. Barrier layers of this type prevent oxygen from penetrating the bottled liquids and prevent the escape of carbon dioxide from carbonated liquids.

Plasma coating is often performed on containers that were produced by blow molding preforms that have first been heated to a suitable temperature. Preforms of this type typically consist of a thermoplastic material, for example, PET (polyethylene terephthalate). After suitable thermal conditioning, the preforms are formed into containers by the action of blowing pressure. These containers are used, for example, as bottles for bottling liquids. In accordance with DE-OS 100 33 412, blowing stations are arranged on a rotating blowing wheel. The blowing wheel rotates continuously, and the blowing stations, which are arranged on the blowing wheel and rotate with it, receive the preforms to be shaped and deliver the finished containers. Moreover, blowing wheels that move in a timed cycle are also already known.

Until now, no one has succeeded in producing containers and in designing equipment for producing containers and preforms to achieve an optimum combination with respect to fulfilling the partly conflicting requirements on economical production of the containers, a high level of environmental friendliness, and a high level of protection of the packaged products from both penetration of unwanted substances and the escape of product constituents.

Therefore, the objective of the invention is to provide a container of the aforementioned type which simultaneously fulfills economic, ecological, and qualitative requirements.

In accordance with the invention, this objective is achieved with a container that is made of a thermoplastic material that contains the constituent that can be released in a concentration that is above the concentration that is allowable for the packaging of the products, such that at least a portion of the inner surface of the wall of the container is coated in such a way that a release rate of the constituent in the direction of the interior of the container is realized which, at most, is equal to a release rate that would be realized with the use of a thermoplastic material which has a concentration of the constituent that can be released that is near the allowable limit but which does not have an inner coating.

A further objective of the present invention is to design an installation of the aforementioned type in such a way that economical production is possible.

In accordance with the invention, this objective is achieved by coupling the injection-molding machine with a reactor for producing the thermoplastic material.

A further objective of the present invention is to develop a method of the aforementioned type that allows economical, ecological, and qualitatively superior production of containers.

In accordance with the invention, this objective is achieved by connecting the reactor directly to the injection-molding machine and feeding the plastic produced by the reactor from the reactor to the injection-molding machine in the form of a melt.

The container of the invention makes it possible to use a relatively inexpensive material and nevertheless to prevent or at least greatly reduce the unallowable release of undesired substances from the container material into a product contained inside the container. The container of the invention especially allows the use of recycled material without the need for the expensive production of multilayer preforms. Furthermore, it is possible to produce the thermoplastic material used for the production of the containers by modified methods or with the use of catalysts other than those that are presently used, since the formation of undesired byproducts or residual catalyst substances is now of only secondary importance.

The installation of the invention and the method of the invention make it possible to avoid high-cost and high-energy intermediate steps in the production of the containers. The direct coupling of the reactor and the injection-molding machine makes it possible to avoid a cooling operation for the material produced in the reactor, granulation of the material, and subsequent reheating and plastication of the granulated material.

Environmentally friendly container production is supported by producing the thermoplastic material at least partly from recycled material.

To make it possible to produce the containers inexpensively, it is proposed that the plastic have an acetaldehyde content of at least 10 ppm. It is also possible for the acetaldehyde content to be at least 50 ppm, and typically 60-100 ppm.

Inexpensive production of the containers is also helped if the plastic contains a catalyst as one of its constituents.

Qualitatively superior container production in high quantities is assisted by the application of the surface coating as a plasma coating.

In the case of food or beverage packaging, it has been found to be especially advantageous if the surface coating is applied as at least one layer of a silicon oxide of general formula SiOₓ.

A typical application consists in shaping the container as a bottle.

In regard to material selection, it is advantageous for the plastic to consist at least partly of PET.

To promote optimum product properties, even when the product is subjected to loads, it is proposed that the surface coating be applied to the surface with the use of an adhesion promoter.

If the wall consists of a single-layer material, this also contributes to inexpensive production of the containers.

To adapt continuous material production to discontinuous material consumption, it is proposed that at least one temporary storage tank for molten thermoplastic material be installed between the reactor and the injection-molding machine.

Simple mechanical control of the filling and emptying of the temporary storage tank is realized by the reciprocating motion of a piston.

A large field of application is opened by designing the reactor as a device for the production of PET.

To further improve the properties of the material with respect to gas permeation and to promote the binding of volatile material constituents within the material, it is proposed that the reactor have a mixing device for supplying a scavenger.

To make it possible to adapt to different production capacities of the reactor and of injection-molding machines coupled with the reactor, it is proposed that at least two injection-molding machines be coupled with the reactor.

Production flexibility can be increased by coupling injection-molding machines that are different from one another to the reactor.

The number of possible applications can be increased by connecting a mixing device for admixing plasticated recycled material at a coupling between the reactor and the injection-molding machine.

Embodiments of the invention are schematically illustrated in the drawings.

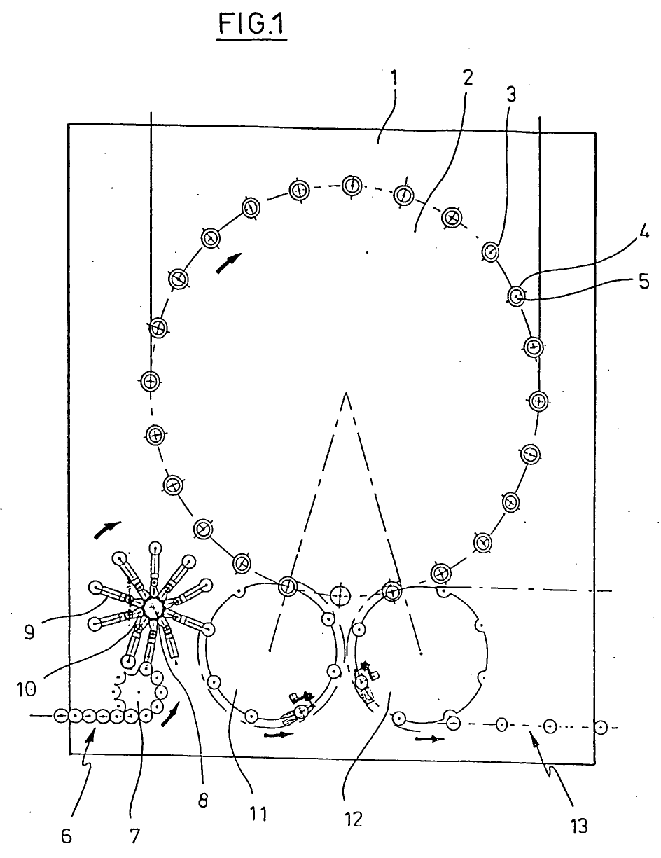

FIG. 1 shows a schematic diagram of a plurality of plasma chambers, which are arranged on a rotating plasma wheel, which is coupled with input and output wheels.

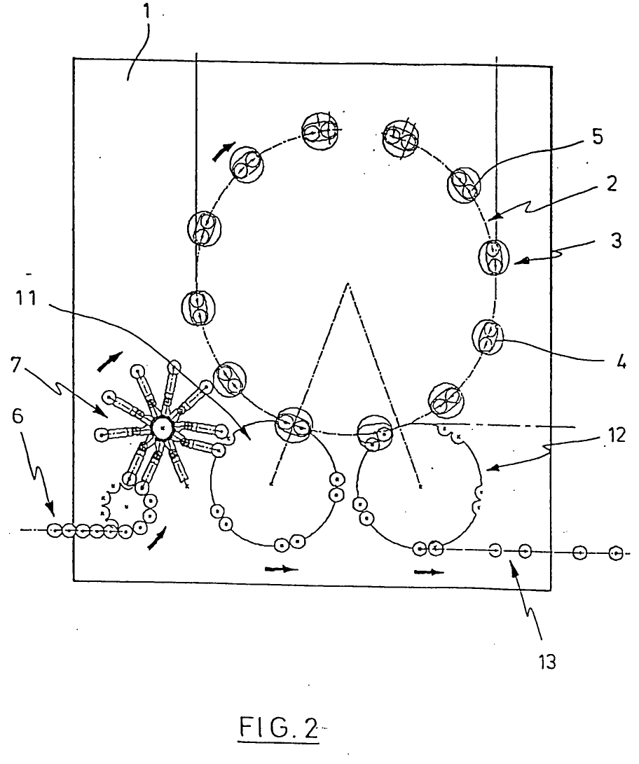

FIG. 2 shows an arrangement similar to FIG. 1, in which each plasma station is equipped with two plasma chambers.

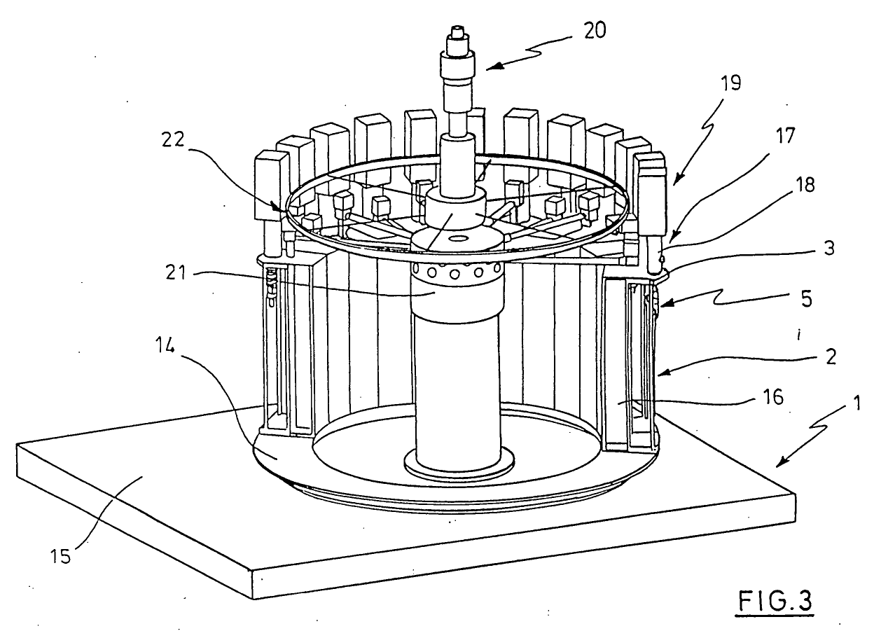

FIG. 3 shows a perspective view of a plasma wheel with a plurality of plasma chambers.

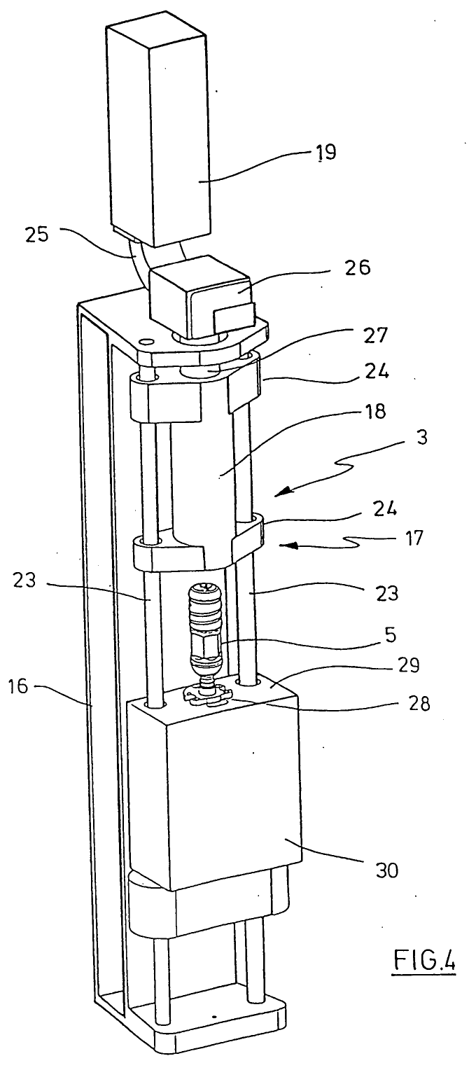

FIG. 4 shows a perspective view of a plasma station with one cavity.

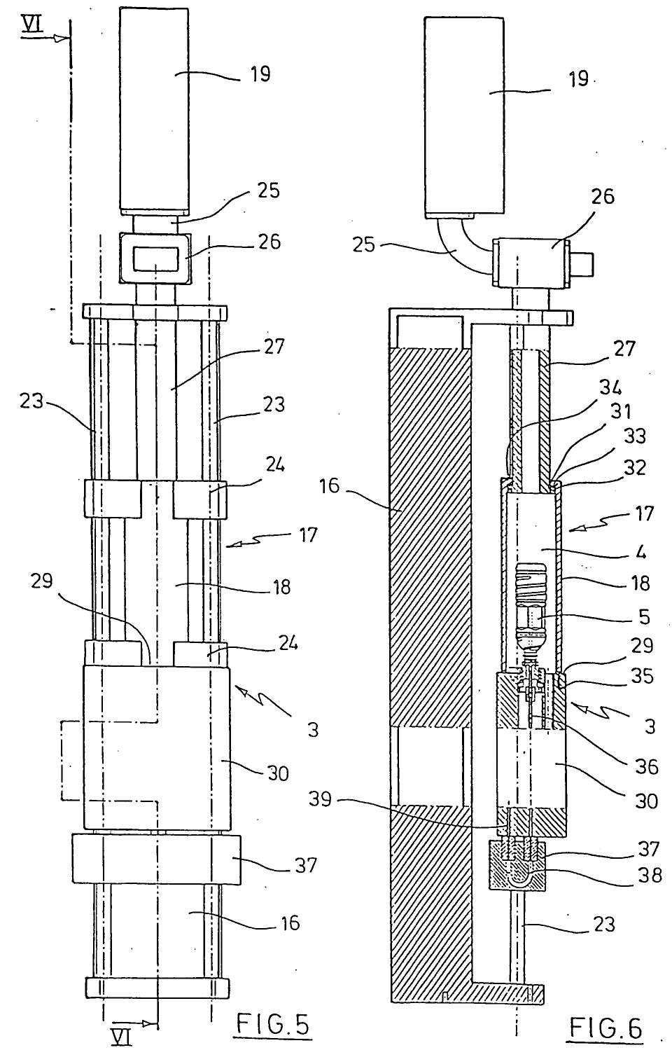

FIG. 5 shows a front elevation of the device in FIG. 4 with the plasma chamber closed.

FIG. 6 shows a cross section along sectional line VI-VI in FIG. 5.

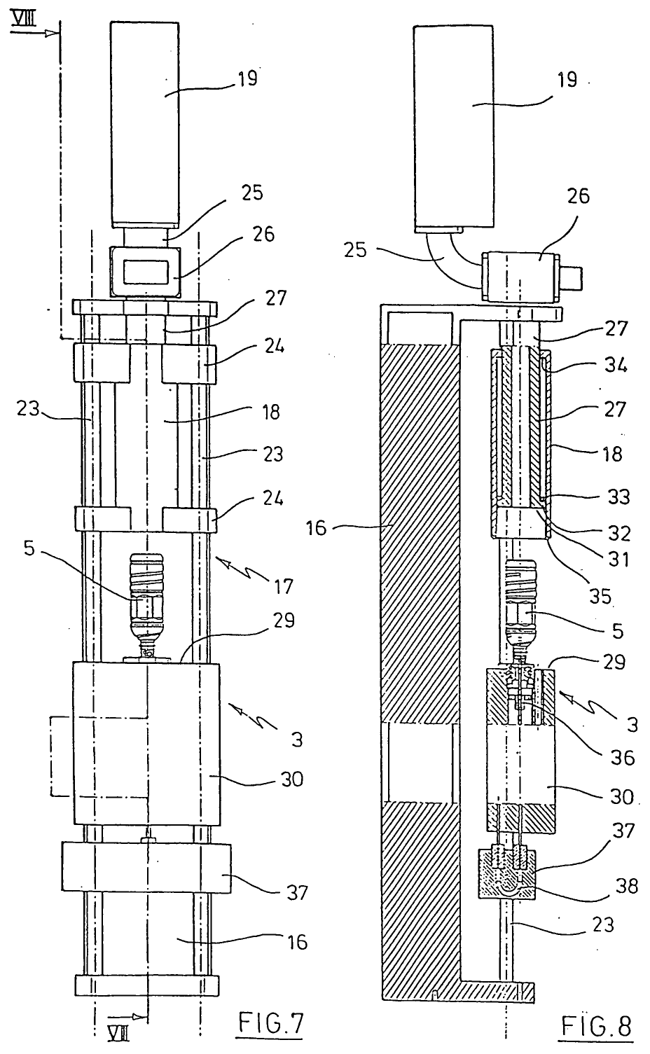

FIG. 7 shows the same view as in FIG. 5 but with the plasma chamber open.

FIG. 8 shows a vertical section along sectional line VIII-VIII in FIG. 7.

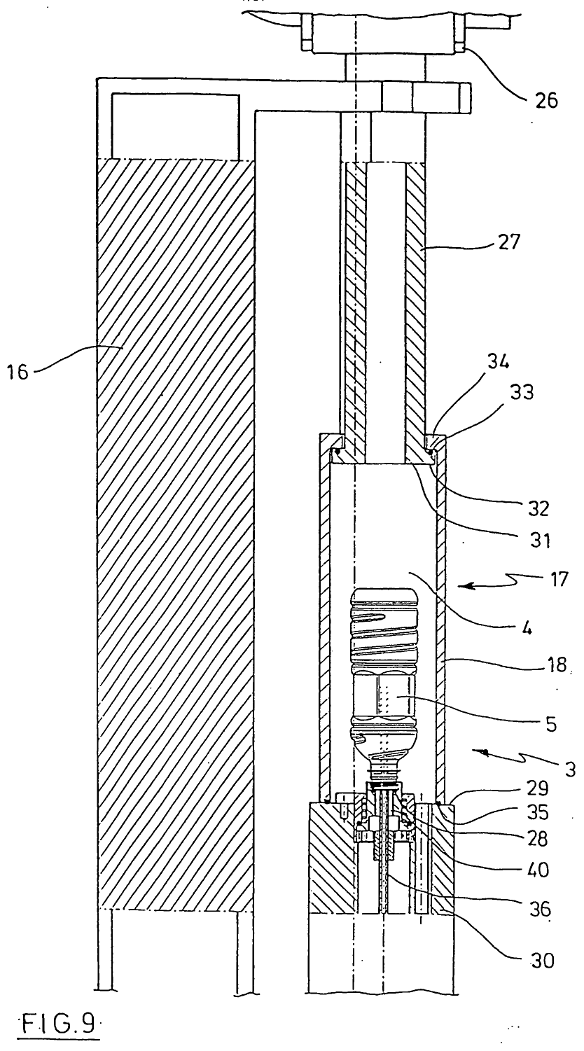

FIG. 9 shows an enlarged view of the plasma chamber with a bottle to be coated in accordance with FIG. 6.

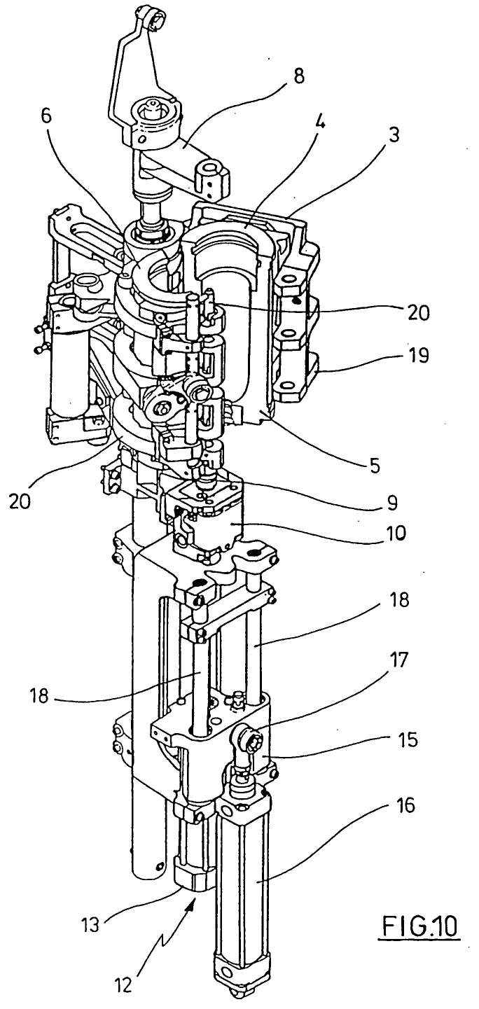

FIG. 10 shows a perspective view of a blowing station for producing containers from preforms.

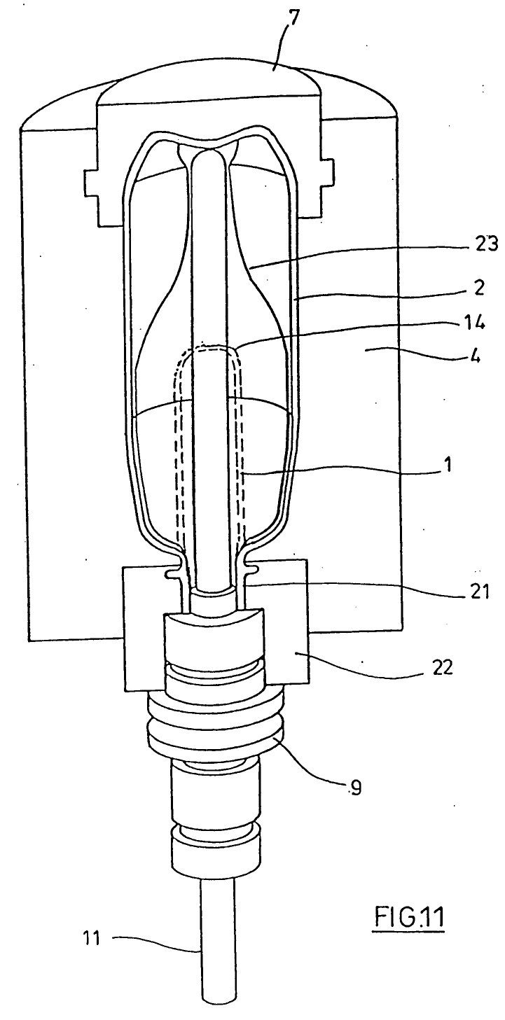

FIG. 11 shows a longitudinal section through a blow mold, in which a preform is being stretched and expanded.

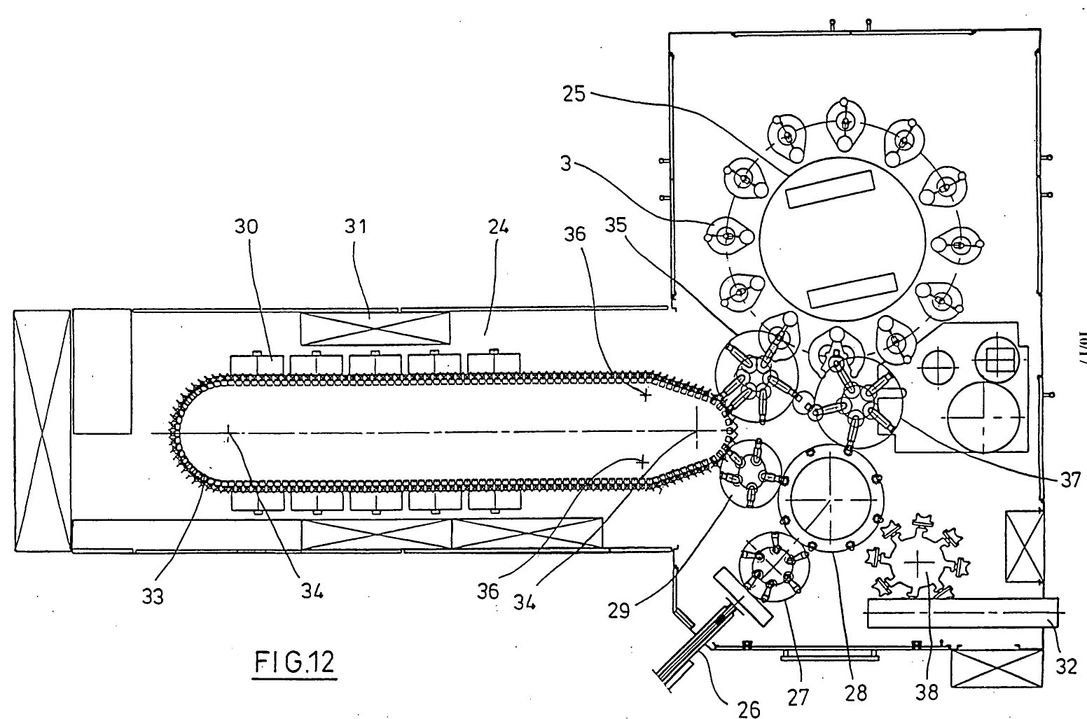

FIG. 12 shows a drawing that illustrates the basic design of a machine for blow molding containers.

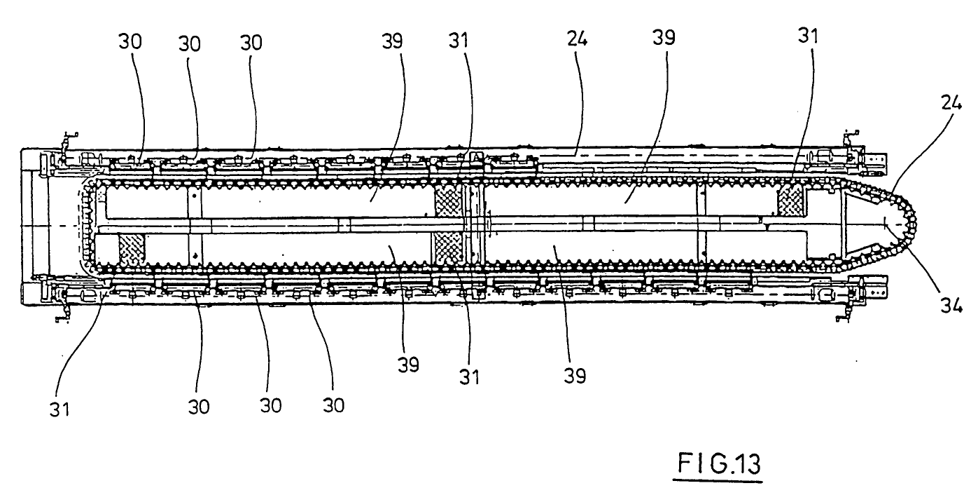

FIG. 13 shows a modified heating line with increased heating capacity.

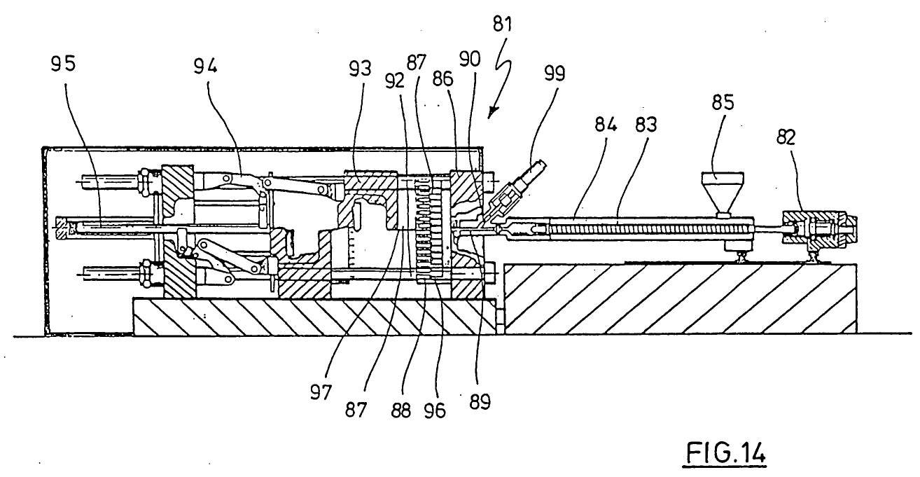

FIG. 14 shows a simplified side view of an injection-molding machine.

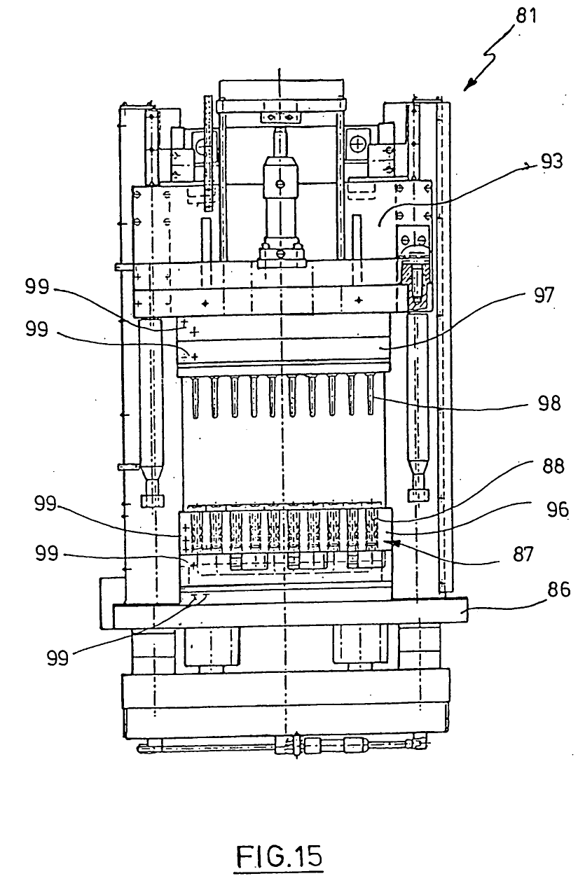

FIG. 15 shows a vertical section through another injection-molding machine.

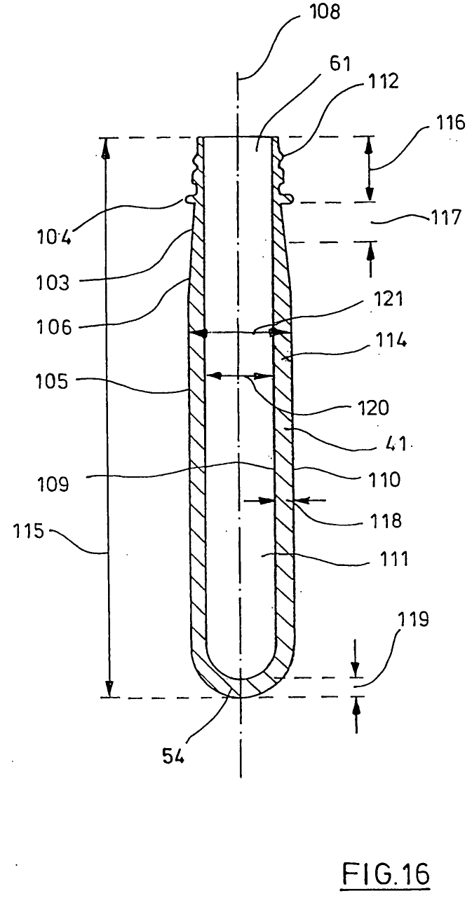

FIG. 16 shows a longitudinal section through a preform.

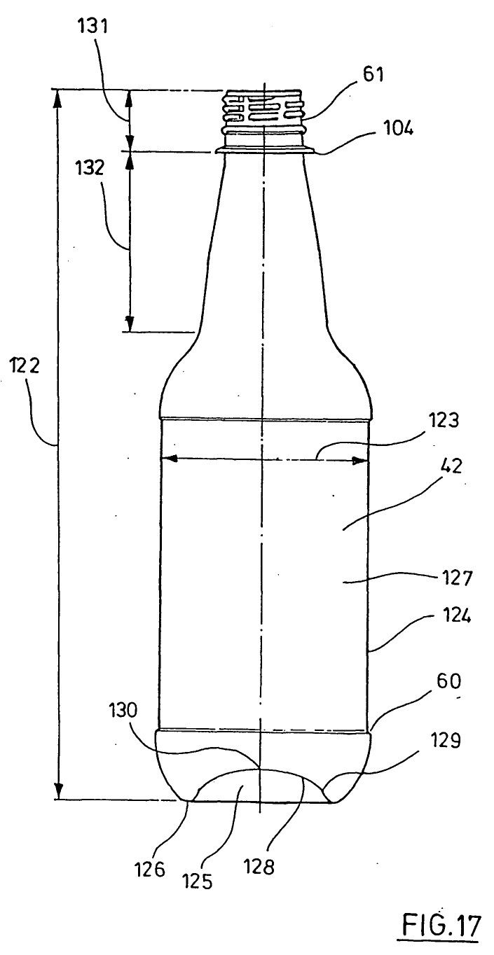

FIG. 17 shows a side view of a blown container.

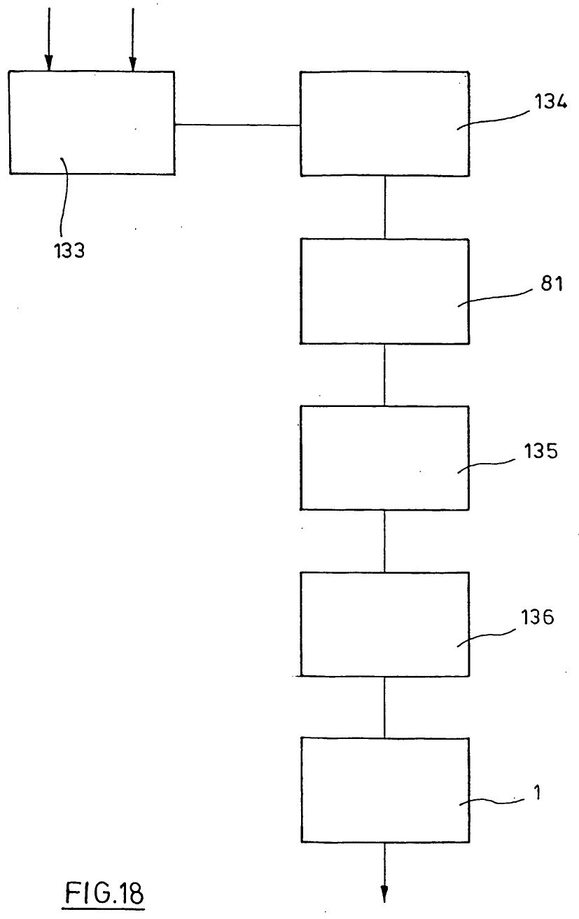

FIG. 18 shows a block diagram illustrating the functional components for the production of containers.

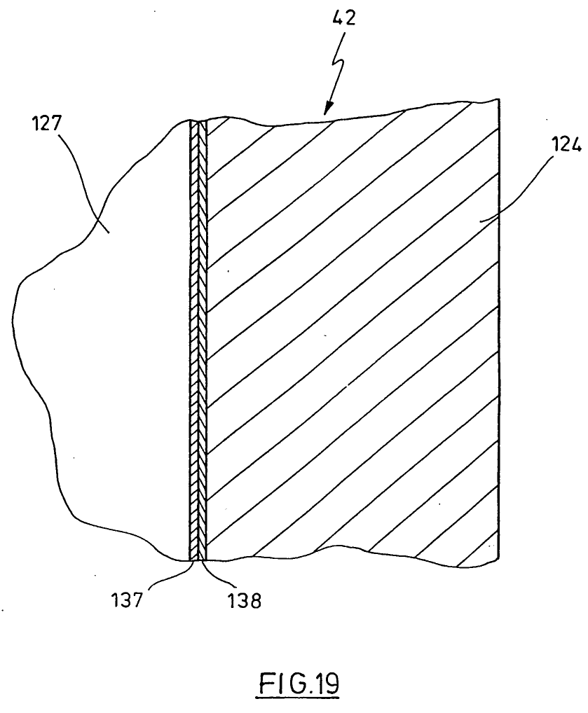

FIG. 19 shows a partial view of a cross section of a container wall.

The individual functional components involved in the production of containers are described below.

The view in FIG. 1 shows a plasma module (1), which is provided with a rotating plasma wheel (2). A plurality of plasma stations (3) is arranged along the circumference of the plasma wheel (2). The plasma stations (3) are provided with cavities (4) and plasma chambers (17) for holding the workpieces (5) that are to be treated. The plasma module (1) is the last stage in the production of the containers. After the plasma treatment, the containers can be filled.

The workpieces to be treated (5) are fed to the plasma module (1) in the region of an input (6) and further conveyed by an isolating wheel (7) to a transfer wheel (8), which is equipped with positionable support arms (9). The support arms (9) are mounted in such a way that they can be swiveled relative to a base (10) of the transfer wheel (8), so that the spacing of the workpieces (5) relative to one another can be changed. In this way, the workpieces (5) are transferred from the transfer wheel (8) to an input wheel (11) with increased spacing of the workpieces (5) relative to one another compared to the isolating wheel (7). The input wheel (11) transfers the workpieces (5) to be treated to the plasma wheel (2). After the treatment has been carried out, the treated workpieces (5) are removed from the area of the plasma wheel (2) by an output wheel (12) and transferred to the area of an output line (13).

In the embodiment shown in FIG. 2, each plasma station (3) is equipped with two cavities (4) and plasma chambers (17). This makes it possible to treat two workpieces (5) at a time. In this connection, it is basically possible to design the cavities (4) completely separate, but it is also basically possible to separate only sections of a common cavity space from each other in such a way that optimum coating of all workpieces (5) is ensured. In particular, it is intended here that the cavity sections be separated from each other at least by separate microwave couplings.

FIG. 3 shows a perspective view of a plasma module (1) with a partially assembled plasma wheel (2). The plasma stations (3) are installed on a supporting ring (14), which is designed as part of a revolving joint and is mounted in the area of a machine base (15). Each plasma station (3) has a station frame (16), which supports plasma chambers (17). The plasma chambers (17) have cylindrical chamber walls (18) and microwave generators (19).

Rotary distributors (20, 21), by which the plasma stations (3) are supplied with operating agents and power, are located in the center of the plasma wheel (2). Especially ring conduits (22) can be used for distribution of the operating agents.

The workpieces (5) to be treated are shown below the cylindrical chamber walls (18). For the sake of simplicity, lower parts of the plasma chambers (17) are not shown in the drawing.

FIG. 4 shows a perspective view of a plasma station (3). The drawing shows that the station frame (16) is provided with guide rods (23), on which a slide (24) for mounting the cylindrical chamber wall (18) is guided. FIG. 4 shows the slide (24) with the chamber wall (18) in its raised position, so that the workpiece (5) is exposed.

The microwave generator (19) is located in the upper region of the plasma station (3). The microwave generator (19) is connected by a guide (25) and an adapter (26) to a coupling duct (27), which opens into the plasma chamber (19). Basically, the microwave generator (19) can be installed directly in the vicinity of the chamber lid (31) or coupled with the chamber lid (31) at a predetermined distance from the chamber lid (31) via a spacing element and thus installed in a larger surrounding area of the chamber lid (31). The adapter (26) acts as a transition element, and the coupling duct (27) is designed as a coaxial conductor. A quartz glass window is installed in the area of the opening of the coupling duct (27) into the chamber lid (31). The guide (25) is designed as a waveguide.

The workpiece (5) is positioned in the vicinity of a sealing element (28), which is located in the vicinity of the chamber floor (29). The chamber floor (29) is formed as part of a chamber base (30). To facilitate adjustment, it is possible to mount the chamber base (30) in the area of the guide rods (23). An alternative is to mount the chamber base (30) directly on the station frame (16). In an arrangement of this type, it is also possible, for example, to design the guide rods (23) in two parts in the vertical direction.

FIG. 5 shows a front elevation of the plasma station (3) of FIG. 3 with the plasma chamber (17) closed. The slide (24) with the cylindrical chamber wall (18) is lowered here relative to the position in FIG. 4, so that the chamber wall (18) is moved against the chamber floor (29). In this position, the plasma coating can be carried out.

FIG. 6 shows a vertical sectional view of the arrangement in FIG. 5. It is especially apparent that the coupling duct (27) opens into a chamber lid (31), which has a laterally projecting flange (32). A seal (33), which is acted upon by an inner flange (34) of the chamber wall (18), is located in the area of the flange (32). When the chamber wall (18) is lowered, the chamber wall (18) becomes sealed relative to the chamber lid (31). Another seal (35) is located in the lower region of the chamber wall (18) to ensure sealing relative to the chamber floor (29).

In the position shown in FIG. 6, the chamber wall (18) encloses the cavity (4), so that both the interior of the cavity (4) and the interior of the workpiece (5) can be evacuated. To assist with the introduction of process gas, a hollow lance (36) is mounted in the area of the chamber base (30) and can be moved into the interior of the workpiece (5). To allow positioning of the lance (36), the lance is supported by a lance slide (37), which can be positioned along the guide rods (23). A process gas duct (38) runs inside the lance slide (37). In its raised position shown in FIG. 6, the process gas duct (38) is coupled with a gas connection (39) of the chamber base (30). This arrangement eliminates hose-like connecting elements on the lance slide (37).

FIG. 7 and FIG. 8 show the arrangement of FIG. 5 and FIG. 6 with the chamber wall (18) in its raised position. When the chamber wall (18) is positioned in this way, the treated workpiece (5) can be removed from the area of the plasma station (3) without any problems, and a new workpiece (5) to be treated can be inserted. Alternatively to the positioning of the chamber wall (18) that is shown in the drawing, with the plasma chamber (17) in an open state produced by upward movement of the chamber wall (18), it is also possible to perform the opening operation by moving a structurally modified, sleeve-like chamber wall vertically downward.

In the illustrated embodiment, the coupling duct (27) has a cylindrical shape and is arranged essentially coaxially with the chamber wall (18).

FIG. 9 shows a vertical section in accordance with FIG. 6 in an enlarged partial view of the area around the chamber wall (18). Especially evident in the drawing are the overlapping of the inner flange (34) of the chamber wall (18) over the flange (32) of the chamber lid (31) and the mounting of the workpiece (5) by the mounting element (28). Furthermore, the drawing shows that the lance (36) passes through a hollow space (40) in the mounting element (28).

A typical treatment operation is explained below for the example of a coating operation. The workpiece (5) is inserted into the plasma station (3) with the sleeve-like chamber wall (18) in its raised position. After completion of the insertion operation, the chamber wall (18) is lowered into its sealed position, and then both the cavity (4) and the interior of the workpiece (5) are evacuated, simultaneously at first.

After sufficient evacuation of the interior of the cavity (4), the lance (36) is inserted into the interior of the workpiece (5), and partitioning of the interior of the workpiece (5) from the interior of the cavity (4) is carried out by moving the sealing element (28). It is also possible already to start moving the lance (36) into the workpiece (5) synchronously with the start of evacuation of the interior of the cavity. The pressure in the interior of the workpiece (5) is then further reduced. Moreover, it is also possible to carry out the positioning movement of the lance (36) at least partly at the same time as the positioning of the chamber wall (18). After a sufficiently low negative pressure has been achieved, process gas is introduced into the interior of the workpiece (5), and the plasma is ignited by means of the microwave generator (19).

In particular, it is intended that the plasma be used to deposit both an adhesion promoter and the actual barrier layer, which consists of silicon oxides, on the inner surfaces of the workpiece (5).

The adhesion promoter can be applied, for example, as the first step of a two-step process before the application of the barrier layer in the second step. However, it is also possible, in a continuous process, to produce at least a portion of the barrier layer that faces the workpiece (5) as a gradient layer even as at least a portion of the adhesion promoter is simultaneously being applied. A gradient layer of this type can be produced in a simple way during the duration of an already ignited plasma by varying the composition of the process gas. This sort of change in the composition of the process gas can be achieved abruptly by changing the valve controls or continuously by changing the mixing proportions of components of the process gas.

A gradient layer is typically formed in such a way that the portion of the gradient layer that faces the workpiece (5) contains at least a preponderance of the adhesion promoter, while the portion of the gradient layer that faces away from the workpiece (5) contains at least a preponderance of the barrier material. In at least a portion of the gradient layer, a transition of the given components occurs continuously according to a predeterminable gradient variation. Similarly, it is possible to produce both the adhesion promoter layer and the barrier layer itself as gradient layers.

The interior of the plasma chamber (17) and the interior of the workpiece (5) are initially evacuated together to a pressure level of about 20 mbars to 50 mbars. The pressure in the interior of the workpiece (5) is then further reduced to about 0.1 mbar. During the treatment process, a negative pressure of about 0.3 mbar is maintained.

After a coating operation has been completed, the lance (36) is withdrawn from the interior of the workpiece (5), and the plasma chamber (17) and the interior of the workpiece (5) are ventilated. After ambient pressure has been reached inside the cavity (4), the chamber wall (18) is raised again to allow the coated workpiece (5) to be removed and a new workpiece (5) to be inserted for coating. To allow lateral positioning of the workpiece (5), the sealing element (28) is moved at least partly back into the chamber base (30).

The chamber wall (18), the sealing element (28), and/or the lance (36) can be positioned by means of various types of drive equipment. In principle, it is possible to use pneumatic drives and/or electric drives, especially in the form of linear drives.

As FIG. 10 shows, a device for blow molding a container (42), which is shown in FIG. 11, consists essentially of a blowing station (43), which contains a blow mold (44), in which a preform (41), which is also shown in FIG. 11, can be inserted. The preform (41) can be an injection-molded part made of polyethylene terephthalate. To allow a preform (41) to be inserted in the blow mold (44) and to allow the finished container (42) to be removed, the blow form (44) consists of mold halves (45, 46) and a base part (47), which can be positioned by a lifting device (48). The preform (41) can be held in the area of the blowing station (43) by a transport mandrel (49), which, together with the preform (41), passes through a plurality of treatment stations within the device. However, it is also possible to insert the preform (41) directly into the blow mold (44), for example, with tongs or other handling devices. The container (42) represents an example of a realization of the workpiece (5) illustrated in connection with the plasma module (1).

To allow the introduction of compressed air, a connecting piston (50) is installed below the transport mandrel (49). It supplies compressed air to the preform (41) and at the same time creates a seal relative to the transport mandrel (49). However, in a modified design, it is also possible to used fixed compressed air lines.

The preform (41) is stretched with a stretching rod 51 (see FIG. 11), which is positioned by a cylinder (52). However, it is also basically possible to accomplish mechanical positioning of the stretching rod (51) by cam segments, which are acted upon by tapping rollers. The use of cam segments is especially advantageous if a large number of blowing stations (43) are arranged on a rotating blowing wheel. The use of cylinders (52) is advantageous if stationary blowing stations (43) are present.

In the embodiment shown in FIG. 10, the stretching system is designed in such a way that a tandem arrangement of two cylinders (52) is provided. The stretching rod (51) is first moved by a primary cylinder (53) as far as the area of a base (54) (see FIG. 11) of the preform (41) before the start of the actual stretching process. During the actual stretching process, the primary cylinder (53) with the stretching rod (51) extended, together with a slide (55) that carries the primary cylinder (53), is positioned by a secondary cylinder (56) or by a cam control mechanism. In particular, it is intended that the secondary cylinder (56) be used in such a way with cam control that a current stretching position is preset by a guide pulley (57), which slides along a curved sector during the performance of the stretching process. The guide pulley (57) is pressed against the guideway by the secondary cylinder (56). The slide (55) slides along two guide elements (58).

After the mold halves (45, 46), which are arranged in the vicinity of supports (59, 60), have been closed, the supports (59, 60) are locked relative to each other by a locking device (80).

As shown in FIG. 11, to allow adaptation to different shapes of a mouth section (61) of the preform (41), provision is made for the use of separate threaded inserts (62) in the area of the blow mold (44). In addition to the blown container (42), FIG. 11 shows the preform (41), which is drawn with broken lines, and a schematic representation of the developing container bubble (63).

FIG. 12 shows the basic design of a blow-molding machine equipped with a heating line (64) and a rotating blowing wheel (65). Starting from a preform input (66), the preforms (41) are conveyed by transfer wheels (67, 68, 69) to the area of the heating line (64). Radiant heaters (70) and fans (71) are arranged along the heating line (64) to suitably adjust the temperature of the preforms (41). After sufficient temperature adjustment of the preforms (41), they are transferred to the blowing wheel (65), where the blowing stations (43) are located. The finished blown containers (42) are fed to an output line (72) by further transfer wheels.

To be able to shape a preform (41) into a container (42) in such a way that the container (42) has material properties that guarantee a long storage life of foods, especially beverages, packaged in the containers (42), specific process steps must be followed in the heating and orientation of the preforms (41). Furthermore, advantageous effects can be realized by following specific dimensioning specifications.

Various plastics can be used as the thermoplastic material. For example, it is possible to use PET, PEN, or PP.

The preform (41) is expanded during the orientation process by supplying compressed air. In a preblowing phase, gas, for example, compressed air, is supplied at a low pressure level, and in a subsequent main blowing phase, gas is supplied at a higher pressure level. During the preblowing phase, compressed air at a pressure of 10-25 bars is typically used, and during the main blowing phase, compressed air is supplied at a pressure of 25-40 bars.

FIG. 12 also shows that, in the illustrated embodiment, the heating line (64) consists of a large number of revolving conveying elements (73), which are joined together like a chain and are guided along by guide pulleys (74). In particular, it is intended that an essentially rectangular-shaped basic clamping path be established by the chain-like arrangement. In the illustrated embodiment, a single relatively large guide pulley (74) is used in the area of the “expansion” of the heating line (64) that faces the transfer wheel (69) and an input wheel (75), and two relatively small guide pulleys (76) are used in the area of adjacent deflections. In principle, however, any other desired types of guides are possible.

To allow the closest possible arrangement of the transfer wheel (69) and the input wheel (75) relative to each other, the illustrated arrangement is found to be especially effective, since three guide pulleys (74, 76) are positioned in the area of the corresponding expansion of the heating line (64), specifically, the smaller guide pulleys (76) in the area of the transition to the linear paths of the heating line (64) and the large guide pulley (74) in the immediate region of transfer to the transfer wheel (69) and to the input wheel (75). As an alternative to the use of chain-like conveying elements (73), it is also possible, for example, to use a rotating heating wheel.

After the blowing of the containers (42) has been completed, the containers (42) are removed from the area of the blowing stations (43) by an extraction wheel (77) and conveyed by the transfer wheel (68) and an output wheel (78) to the output line (72).

In the modified heating line shown in FIG. 13, the larger number of radiant heaters (70) allows a larger number of preforms (41) to be heated per unit time. The fans (71) introduce cooling air into the area of cooling air ducts (79), which are located opposite the associated radiant heaters (70) and deliver the cooling air through discharge ports. A direction of flow essentially transverse to the direction of conveyance of the preforms (41) is realized by the arrangement of the discharge directions. The cooling air ducts (79) can have reflectors for the radiant heat in the area of surfaces located opposite the radiant heaters (70). It is also possible to use the delivered cooling air to cool the radiant heaters (70).

FIG. 14 shows the basic design of an injection-molding machine (81) in a side view. An injection unit (82) drives a plasticating screw (83), which is supported inside a sleeve (84). Granulated plastic is supplied through a resin feed hopper (85). Heating elements (not shown) are arranged along the sleeve (84) to heat the granulated plastic feed.

A stationary mold part (96) of an injection-molding mold (87) with cavities (88) is arranged in the area of a mounting plate (86). The cavities (88) are connected with the inside of the sleeve (84) by a melt channel (89). A connecting channel (90) of a holding pressure unit (91) also opens into the melt channel (89). The feeding of the plasticated plastic to the cavities (88) is coordinated by control devices (not shown).

A movable mounting plate (93), on which a movable mold part (97) of the injection-molding mold (87) is mounted, can be positioned along sidepieces. When the mounting plates (86, 93) are moved towards each other, the two tool parts (96, 97) of the injection-molding mold (87) together bound the cavities (88).

The movable mounting plate (93) is positioned by means of an adjusting mechanism (94), which is operated by a locking cylinder. The adjusting mechanism (94) can be designed with the use of toggle mechanisms.

In accordance with the embodiment in FIG. 14, the cavities (88) are arranged with their longitudinal axes in the horizontal direction.

FIG. 15 shows an embodiment in which the cavities (88) are positioned with their longitudinal axes essentially vertical. In this embodiment as well, the injection-molding mold (87) consists of a stationary mold part (96) and a movable mold part (97). The stationary mold part (96) is provided with the cavities (88), into which injection-molding cores (98) can be inserted. After the movable mold part (97) has been moved into the stationary mold part (96), the cavities have a contour similar to the shape of a test tube.

In particular, the drawing in FIG. 15 shows that connections (99) for supplying and removing cooling medium are provided both in the area of the stationary mold part (96) and in the area of the movable mold part (97). The connections (99) open into cooling channels (not shown in this drawing), which pass through the mold parts (96, 97).

In the embodiment shown in FIG. 16, a preform (41) consists of a mouth section (61), a neck ring (104) separating the mouth section (61) from a neck region (103), a shoulder region (106) that provides a transition from the neck region (103) to the wall section (105), and a base (54). The neck ring (104) projects beyond the mouth section (61) in a direction transverse to the longitudinal axis (108) of the preform. In the shoulder region (106) the outside diameter of the preform (41) increases from the neck region (103) towards the wall section (105). In a container (42) to be produced from the preform (41), the wall section (105) forms essentially the sidewall of the container (42). The base (54) is rounded.

The mouth section (102) can be provided, for example, with an external thread (112), which makes it possible to close the finished container (42) with a screw cap. However, it is also possible to provide the mouth section (102) with an external bead to create a working surface for a crown cap. Furthermore, there are many other conceivable designs that allow a closure device to be placed on the container.

The drawing in FIG. 16 shows that the wall section (105) has an inside surface (109) and an outside surface (110). The inside surface (109) defines an interior space (111) of the preform.

In the shoulder region (106), the thickness of a preform wall (114) can increase from the neck region (103) towards the wall region (105). In the direction of the longitudinal axis (108) of the preform, the preform (41) has a preform length (115). The mouth region (102) and the neck ring (104) extend in the direction of the longitudinal axis (108) of the preform with a common mouth length (116). The neck region (103) has a neck length (117) in the direction of the longitudinal axis (108) of the preform. The neck region (103) of the preform (41) preferably has a constant wall thickness along its length.

The wall region (105) of the preform (41) has a wall thickness (118), and the base region (107) has a base thickness (119). The dimensions of the preform (41) can be further specified on the basis of its inside diameter (120) and its outside diameter (121), which are measured in the approximately cylindrical wall region (105).

In the bottle-shaped container (42) shown in FIG. 17, the mouth section (61) and the neck ring (104) are essentially unchanged. The remainder of the container (42) is expanded relative to the preform (41) in both the transverse direction and the longitudinal direction by the biaxial orientation. This gives the container (42) a container length (122) and a container diameter (123). In view of the accuracies to be considered, there is no longer any need to make a distinction between the precise inside diameter and the precise outside diameter.

FIG. 17 also shows the base region of the blow-molded container (42). The container (42) has a sidewall (124) and a container base (125). In the illustrated embodiment, the container base (125) consists of an annular ring (126) on which the container stands and a dome (128) that curves inwardly in the direction of the interior (127) of the container. The dome (128) consists of a dome slope (129) and a center (130).

The container (42) has a container mouth length (131) and a container neck length (132), and at least the container mouth length (131) is generally the same as the mouth length (116) of the preform (41).

FIG. 18 schematically illustrates the interaction of the individual production components for the production of a finished container (42). The components required for the production of the thermoplastic material are mixed in the vicinity of a reactor (133) and are then subjected to a chemical reaction in the reactor (133). The thermoplastic material produced by the reactor (133) is then fed into a melt storage tank (134). The melt storage tank (134) bridges the continuous production of thermoplastic material by the reactor (133) and the cyclical removal of thermoplastic material by the injection-molding machine (81). Typically, the melt storage tank (134) is thermally insulated to minimize heat loss.

To carry out a so-called two-step container production process, the preforms (41) produced by the injection-molding machine (81) are first sent to an intermediate storage location (135), in which they cool to ambient temperature. The preforms (41) are then further conveyed from the intermediate storage location (135) to a blow-molding machine (136), which is equipped with the blowing stations (43) described earlier. To carry out a so-called one-step process, either the intermediate storage location (135) is completely eliminated, or the intermediate storage is relatively brief without cooling of the preforms (41) to ambient temperature.

After the preforms (41) have been shaped into containers (42), the containers (42) are transferred from the blow-molding machine (136) to the plasma module to receive the required surface coating.

FIG. 19 illustrates the configuration of a barrier layer (137) produced on the wall of the container (42) by the plasma process. In the illustrated embodiment, the barrier layer (137) is bonded to the container wall with the use of a layer of adhesion promoter (138). In principle, however, it is also possible either to apply the barrier layer (137) directly on the container layer or to realize a smooth transition between the layers (137, 138) in the form of a gradient layer.

The constituents that can be released into the interior of the container can also arise, for example, by decomposition of the material of the container by aging or by external influences. In general, the use of the inner coating of the container also makes it possible to use materials that would be attacked or destroyed by the action of the contents of the container. Finally, the use of the inner coating makes it possible to use materials with high concentrations of harmful substances, which otherwise could not be used for packaging the intended products. A preferred use is the packaging of liquid foods, with which the use of uncoated container materials would lead to contamination of the foods or deformation of the containers.

1. Container for packaging products, which has a wall made of a thermoplastic material that contains at least one constituent that can be released at least from certain regions of the container into the interior of the container, wherein the constituent that can be released is present in the thermoplastic material in a concentration that is above the concentration that is allowable for the packaging of the products, and that at least a portion of the inner surface of the wall of the container is coated in such a way that a release rate of the constituent in the direction of the interior of the container is realized which, at most, is equal to a release rate that would be realized with the use of a thermoplastic material which has a concentration of the constituent that can be released that is near the allowable limit but which does not have an inner coating.

2. Container in accordance with claim 1, wherein the thermoplastic material consists at least partly of recycled material.

3. Container in accordance with claim 1, wherein the plastic has an acetaldehyde content of at least 10 ppm.

4. Container in accordance with claim 1, wherein the plastic contains a catalyst as one of its constituents.

5. Container in accordance with claim 1, wherein the surface coating is applied as a plasma coating.

6. Container in accordance with claim 1, wherein the surface coating is applied as at least one layer of a silicon oxide of general formula SiOₓ.

7. Container in accordance with claim 1, wherein the container is shaped in the form of a bottle.

8. Container in accordance with claim 1, wherein the plastic consists at least partly of PET.

9. Container in accordance with claim 1, wherein the surface coating is applied to the surface with the use of an adhesion promoter.

10. Container in accordance with claim 1, wherein the wall consists of a single-layer material.

11. Installation for producing preforms from a thermoplastic material, which has an injection-molding machine with cavities for the preforms, wherein the injection-molding machine is coupled with a reactor for producing the thermoplastic material.

12. Installation in accordance with claim 11, wherein at least one temporary storage tank for molten thermoplastic material be installed between the reactor and the injection-molding machine.

13. Installation in accordance with claim 12, wherein the filling and emptying of the temporary storage tank is controlled by the reciprocating motion of a piston.

14. Installation in accordance with claim 11, wherein the reactor is designed as a device for producing PET.

15. Installation in accordance with claim 11, wherein the reactor has a mixing device for supplying a scavenger.

16. Installation in accordance with claim 11, wherein at least two injection-molding machines are coupled with the reactor.

17. Installation in accordance with claim 16, wherein injection-molding machines that are different from one another are coupled with the reactor.

18. Installation in accordance with claim 11, wherein a mixing device for admixing plasticated recycled material is connected at a coupling between the reactor and the injection-molding machine.

19. Method for producing containers from a thermoplastic material, in which the plastic is produced in a reactor and then shaped into preforms by an injection-molding machine, and in which the preforms are formed into containers by blow molding, and then at least a portion of the inner surface of the containers is coated by a plasma coating process, wherein the reactor is directly connected to the injection-molding machine, and that the plastic produced by the reactor is fed from the reactor to the injection-molding machine in the form of a melt.

20. Method in accordance with claim 19, wherein several injection-molding machines are supplied by a common reactor.

21. Method in accordance with claim 19, wherein the reactor produces a polymer.

22. Method in accordance with claim 19, wherein the reactor produces PET.

23. Method in accordance with claim 19, wherein at least a portion of the plastic melt produced by the reactor is temporarily stored before it is processed by injection molding.

24. Method in accordance with claim 19, wherein recycled material is admixed with the melt before the melt is injected into cavities of the injection-molding machine.

25. Method in accordance with claim 19, wherein at least one scavenger is admixed with the material.
